(19) United States
(12) Patent Application Publication
(10) Pub. No.: US 2025/0161947 A1
(43) Pub. Date: May 22, 2025

(54) A METHOD FOR MARKING OBJECTS MADE OF PLASTIC FOR LABORATORY USE AND AN OBJECT PRODUCED USING SAID METHOD

(71) Applicant: Eppendorf SE, Hamburg (DE)

(72) Inventors: Thomas Kamps, Hamburg (DE); Axel Cramer, Hamburg (DE)

(73) Assignee: Eppendorf SE, Hamburg (DE)

(21) Appl. No.: 18/730,479

(22) PCT Filed: Dec. 19, 2022
(86) PCT No.: PCT/EP2022/086643

§ 371 Date: Jul. 19, 2024

(30) Foreign Application Priority Data
Jan. 20, 2022 (EP) 22152440.8

(51) Int. Cl. B01L 3/00; B41M 5/26

(52) U.S. Cl. CPC B01L 3/545; B41M 5/267; B01L 2300/0829

(57) ABSTRACT

A method for marking objects made of plastic for laboratory use includes producing a contrast surface on the plastic of the object using at least one laser beam and producing a writing in the contrast surface using at least one laser beam. When the contrast surface is light-colored, the writing is dark-colored, and when the contrast surface is dark-colored, the writing is light-colored.

### CROSS-REFERENCE TO RELATED APPLICATIONS

This application is based upon and claims priority to, under relevant sections of 35 U.S.C. § 119, PCT Application No. PCT/EP2022/086643, filed Dec. 19, 2023, which is based on European Patent Application No. 22152440.8, filed Jan. 20, 2022, the entire contents of which are hereby incorporated by reference.

### TECHNOLOGICAL FIELD

The following disclosure is directed to a method for marking objects made of plastic for laboratory use, and to an object made of plastic for laboratory use, said object comprising a marking by the method.

### BACKGROUND

In biology, chemistry, biochemistry, medical, forensic, or other laboratories, in particular microplates, slides, cuvettes, cell culture vessels, reaction vessels, pipette tips, or trays or racks for holding pipette tips or vessels are used. These are preferably single-use items, which are only used once to prevent carryover between different samples. However, there are also reusable laboratory items, for example trays or racks, that can be fitted with pipette tips or vessels from refill packs.

For clear labeling of objects for laboratory use (laboratory items), barcodes are being used more and more often, with which reliable tracking or allocation of the objects can be ensured using a batch and/or serial number.

In many cases, laser marking is suitable for providing objects made of plastic with barcodes (barcoding), since no geometric or material changes need to be made on the object and the investment costs are reasonable.

When marking the objects using laser beams, typically an optical contrast is produced on the object, such that the lasered image of the barcode can be read out with a camera.

In this case, there are usually two different cases to differentiate: a good contrast is produced on dark-colored (in particular black, blue, dark-green) objects in that a color change to a light color is generated by the laser beams. Accordingly, for light-colored objects, a color change with a darker color leads to good results.

It has been shown that it is difficult to produce an easily readable contrast on objects of certain colors. These include, in particular, the light- and medium-gray colors, many yellow tones, and red and light-green colors. In these cases, the color change after lasering does not appear strong enough to allow a camera to detect distinct color differences.

U.S. Pat. No. 6,372,293 describes a test tube that is open at the top and has a machine-readable code on the flat underside of a base. The code is produced using a multilayer coating on the outer side of the base. The multilayer coating comprises a first layer made of opaque material deposited on the underside of the base, and a second layer made of opaque material deposited on the first layer. The machine-readable code is formed by removing parts of the second layer using laser beams. It is disadvantageous that damage to the coating can lead to illegibility of the labeling. In addition, reading out the code can be made more difficult due to it being applied to the underside. Furthermore, manufacturing is complex, since the multilayer coating must be applied before labeling.

WO 2010/023102 A1 describes a sample tube for biochemical and biological research and clinical diagnostics having an identification part on the underside of a flat base. This is composed of a nontransparent material with a first color and a transparent covering layer, which comprises a laser-sensitive filler. When irradiated with a laser writing beam, the irradiated surface of the transparent covering layer is transformed into a nontransparent surface with a second color, which contrasts the first color. The sample tube also has the disadvantages above that are associated with a multilayer coating for the laser marking.

WO 2011/135398 A1 describes marking a transparent container such as a syringe body or a vessel for administering medications, in which a dye spot is applied to the outer side of the transparent wall, the transparent wall is heated, and a data matrix is engraved into the dye spot using laser beams. This is intended to achieve a marking of the container without impairing the mechanical properties, such as the impact resistance, of the transparent container wall. The transparent container also has the disadvantages above that are associated with an additional coating.

EP 2 805 770 B1 describes a container for laboratory application having a body, to which an opaque layer is applied, which has recesses in the form of machine-readable data. The body has at least one local material change, which, together with the opaque layer, forms a reading region, in which the machine-readable data can be captured from the outside by an optical reader due to the optical contrast between the material change and the opaque layer. The recesses in the opaque layer and/or the material change of the body are produced, in particular, using a laser. By applying the machine-readable data directly to or, respectively, in the body, reliable labeling should be provided which cannot be removed from the body. In the case of this container, too, the legibility of the data can be impaired by damage to the opaque layer. In addition, the manufacturing effort is increased by the application of the opaque layer.

EP 2 870 998 B1 describes a sample tube for chemical and biological tests that is formed in one piece from a homogeneous and light-permeable material. The material is manufactured from a homogeneous mixture of a base polymer from the metallocene polyolefin family and a polypropylene-based master batch with a laser-sensitive additive, which changes color to a brown-black color or another contrast color due to excitation by a laser marker. It is disadvantageous that contained samples can be contaminated by the laser-sensitive additive. In addition, the effort for manufacturing is increased by the use of the special plastic mixture.

EP 3 003 536 B1 describes a sample tube comprising a main body made of a first component and a writable region made of a second component. The sample tube is manufactured in a single piece from the first and the second component in a multicomponent injection molding method. The first and the second component comprise the same polymer as the main component and the second component comprises an additive, which can be written on by laser irradiation. The complex manufacturing using multiple components, one of which comprises an additive, which can contaminate the sample, is disadvantageous.

Starting from this, the object of the invention is to create a method for marking objects made of plastic for laboratory use and an object made of plastic for laboratory use, in which the marking can be easily read and is protected from damage. It particular, good legibility should also be provided when the color of the object is light-to medium-gray, a yellow tone, red, or light green.

### SUMMARY

An embodiment of a method for marking objects made of plastic for laboratory use according to the invention includes producing a dark-colored contrast surface is in the plastic of the object using laser beams, and producing a light-colored writing in the dark-colored contrast surface using laser beams, or producing a light-colored contrast surface in the plastic of the object using laser beams, and producing a dark-colored writing in the light-colored contrast surface using laser beams.

An embodiment of an object according to the invention is made of plastic for laboratory use has a marking. The marking comprises a dark-colored contrast surface and a light-colored writing in the dark-colored contrast surface. In another embodiment, the marking comprises a light-colored contrast surface and a dark-colored writing in the light-colored contrast surface, wherein the dark-colored region is a carbonized region of the plastic of the object and the light-colored region is a microfoamed region of the plastic of the object.

According to another embodiment, the contrast and thus the legibility of the marking is increased in that a contrast surface, and a writing in the contrast surface, is generated using laser beams. Either the contrast surface is dark and the writing is light-colored, or the contrast surface is light and the writing is dark-colored. This is achieved in that the plastic is carbonized in the dark-colored region and the plastic is microfoamed in the light-colored region using the laser beams. During carbonization, macromolecules in the plastic are carbonized and turn dark or, respectively, black. During microfoaming, gas bubbles form in the plastic due to the heat effect of the laser radiation and cause a light or, respectively, whitish swelling of the plastic. According to the invention, markings that are more contrast-rich and easier to read can be produced in objects made of plastic with any colors and even those made of colorless plastics.

Preferably, objects comprised of a plastic with a color that until now has not enabled marking with a good contrast, in particular with light-to medium-gray, yellow, red, or light-green colors, are marked according to the invention. However, the invention is also suitable for more easily readable marking of objects made of plastics that could already be marked well, for example in the case of plastics with white, dark-green, blue, or black colors.

Because the marking is formed in the plastic of the object, it does not require applying a coating or another marking carrier, which eliminates the risk of the marking carrier detaching or becoming damaged with the result that the marking can no longer be read. This also eliminates the manufacturing effort associated with applying the marking carrier.

According to another embodiment, the marking can be applied to largely any freely selectable points on the object at high speed during the production process. The position of the marking on the object can be selected, in particular, with regard to good legibility. The marking can be positioned, in particular, on a side of the object that can be captured easily using a camera during use.

In an embodiment, the marking can be produced in the plastic of the object without admixing of additives, such that contamination of samples through contact with the additives can be avoided. The strength and other mechanical properties of the object are not impaired by the marking or are only impaired to a negligibly small degree.

Additional materials are not required for manufacturing the marking and there is no waste. The marking is resistant to damage, in particular, from mechanical or chemical effect, heat, cold, or light.

The marking is applied to the object such that it can be captured from the outside using a camera or another reader or visually. For this purpose, in the case of an object made from an opaque plastic, the marking is preferably applied to the surface of an outer side of the object. In particular in the case of an object made of a transparent or more or less light-permeable material, the marking can also be arranged on the surface of an outer side, between the inner and outer sides or on the surface of the inner side. The focus of the laser beam during marking can be set accordingly for the desired positioning of the marking.

According to an embodiment of the method, the contrast surface is produced in the plastic by leaving regions free for the writing, and the writing is produced only within the regions that have been left free, or the writing is produced in the plastic and the contrast surface is produced in the plastic only next to the writing. This allows particularly strong contrasts to be achieved and minimizes changes in the plastic.

According to another embodiment, the contrast surface is produced in the plastic and is partially overwritten by the writing, or the writing is produced in the plastic material and the contrast surface is produced partially over the writing in the plastic material. Surprisingly, it has been shown that improved contrasts of the marking can also be achieved when the surfaces that have been colored using the laser beams overlap each other. Evidently, the dark coloring caused by the carbonized macromolecules also clearly stands out from the light coloring within a microfoamed region.

According to another embodiment, the writing and the contrast surface are produced using the same laser, and one or more parameters of the laser writing of the laser are changed to produce the contrast surface and the writing. The use of the same laser for the contrast surface and the writing is advantageous for the precise alignment of the contrast surface and the writing in relation to each other. In addition, this also keeps the amount of equipment required low.

According to another embodiment, the writing and the contrast surface are produced using different lasers. By using different lasers, the production speed can be increased, since the contrast surface and the writing can be produced at the same time. When marking the object using different lasers, different laser types that are particularly well suited for each coloring can be used for the light coloring and the dark coloring in order to produce particularly strong contrasts.

According to another embodiment, at least one of the following parameters of the laser is set for the production of the writing and/or the contrast surface: power, pulse speed, scan speed, track width, focus, or color of the laser. This can be used to produce the contrast surface and the writing using the same laser, wherein the setting of the parameters can be changed in each case to produce the contrast surface and the writing. Being able to set the parameters can also be used, however, to permanently set different lasers in each case so that one laser produces the contrast surface and another laser produces the marking. According to another embodiment, the laser(s) is/are a marking laser.

According to another embodiment, the at least one laser is selected from the following group of lasers: CO₂ marking laser, YVO₄ marking laser, fiber marking laser, or SHG marking laser. The laser is preferably a YVO₄ marking laser or a CO₂ marking laser, since these laser types are very well suited to producing a color change in the plastic.

According to another embodiment of the method, the object is provided with the marking by the manufacturer of the object. According to another embodiment, the object is provided with a marking by the user of the object. The user is, for example, a filler who fills the object with a reagent, a composition of active substances, or the like, or the user of the object in a laboratory who examines samples with the aid of the object. The marking can be used by the user, in particular, to identify a contained reagent, composition of active substances, or sample.

According to one embodiment of the method and of the object, the plastic has a light-to medium-gray, yellow, red, or light-green color. As already explained, it is difficult to mark plastics with the mentioned colors in a manner that is easily readable and, according to the invention, a great improvement in legibility is achieved.

According to another embodiment of the method and of the object, the plastic contains at least one additive, which brings about a stronger color change when lasered. This embodiment is considered, in particular, when the object or a part of the object made from the plastic does not come into contact with a sample or the additive is inert with regard to the sample.

According to another embodiment of the invention and of the object, the writing is a barcode and/or a 2D code. According to another embodiment, the 2D code is a data matrix code or a QR code.

According to another embodiment of the method and of the object, the at least one plastic of the object is selected from the following group of plastics: polypropylene, polyethylene, polycarbonate, polystyrene, and styrene copolymers such as ABS. The object can consist of only a single one of the mentioned plastics or of multiple of the mentioned plastics. The plastics can be connected to each other, in particular, in a multicomponent injection molding method. The object can be a single piece or have multiple pieces.

According to another embodiment of the method and of the object, the object is provided with multiple markings that are separated from each other, each comprising a contrast surface and a writing, or, respectively, the object has multiple markings that are separated from each other, each comprising a contrast surface and a writing.

### BRIEF DESCRIPTION OF THE DRAWINGS

The invention is explained in more detail below based on the accompanying drawings of exemplary embodiments.

FIG. 1 illustrates a perspective top view or an embodiment of a microplate according to the invention with two-color markings.

FIG. 2 illustrates an enlarged front view of a portion of an embodiment of the microplate.

FIG. 3 schematically illustrates an embodiment of the production of a marking using a laser.

FIG. 4a illustrates a front view of an embodiment of a conventional single-color marking.

FIG. 4b illustrates a front view of an embodiment of a two-color marking according to the invention with light writing on a dark contrast surface.

FIG. 4c illustrates a front view of an embodiment of a two-color marking according to the invention with dark writing on a light contrast surface.

### DETAILED DESCRIPTION

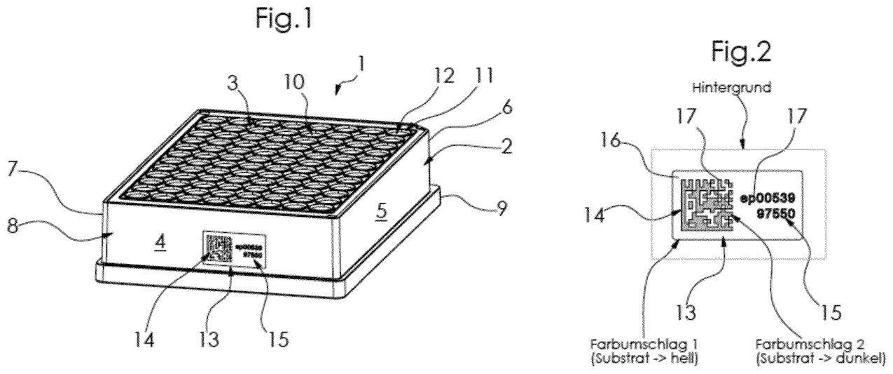

According the embodiment of FIG. 1, a microplate 1 comprises a frame 2 with a substantially rectangular, planar plate 3 and four side walls 4, 5, 6, 7 directed vertically downwards from the four lateral edges of the plate 3, which together form a shell 8.

The shell 8 comprises a circumferential widening 9 at the bottom, which is configured to accommodate the upper edge of an identically designed microplate 1 in order to stack multiple microplates on top of each other.

A plurality of tubular vessels 10 are connected to the plate 3. The vessels 10 are each connected at their upper edge to the plate 3. In the plane of the plate 3, they each have an opening 11 that is accessible from above. Furthermore, they each have a tubular holder 12 which protrudes downwards from below the plate 3 and is closed at the bottom by a base.

FIG. 1 shows an embodiment of a microplate 1 in which the vessels 10 are particularly deep and the shell 8 is particularly high. This embodiment is also referred to as a “deep-well plate.”

The openings 11 of the vessels are arranged in the plate 3 in eight rows and 12 columns, such that there are a total of 96 vessels 10. The microplate 1 is standardized in accordance with ANSI/SBS Standard 1-2004. In an embodiment, the microplate 1 is manufactured in one piece from a plastic (e.g., polypropylene). In an embodiment, the plastic comprises a yellow color.

According to FIGS. 1 and 2, a marking 13 comprising a data matrix code 14 and an alphanumeric product identifier 15 is arranged on the outer side of the side wall 4. The marking 13 comprises a light-colored contrast surface 16 and a dark-colored writing 17 within the contrast surface 16, which comprises the data matrix code 14 and the alphanumeric product identifier 15.

Within the contrast surface 16, the yellow-colored plastic of the microplate 1 comprises a color change from the yellow color to a light (e.g., light-green) color tone. Within the writing 17, the plastic of the microtiter plate 1 comprises a color change from the yellow color to a dark or, respectively, black color.

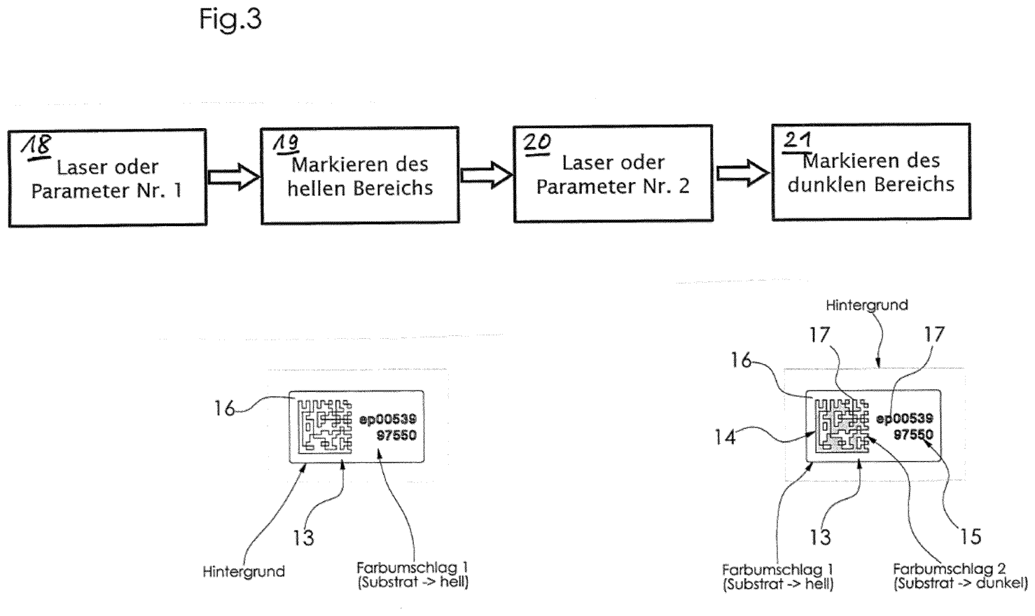

In FIG. 3, the method for marking the microplate 1 from FIG. 1 or another object is shown schematically. In a first step 18, a laser is provided or, respectively, parameters of a laser are set such that the laser beams of the laser cause a color change from the given (e.g.: yellow) base color of the object to a gray that is as light as possible. In the process, the laser usually has a higher marking intensity than when manufacturing the dark writing.

According to a second step 19, the light contrast region is marked in that the laser beam of the laser set or, respectively, provided in this manner irradiates the region of the object in which the contrast surface 16 should be formed. In the process, the regions in which the writing 17 is to be produced are preferably left free.

In a third step 20, a laser is provided or, respectively, parameters of a laser are set such that the irradiation of the object with the laser beam of the laser causes a color change from the base color to a gray that is as dark as possible. In the process, the marking intensity of the laser is usually lower than when manufacturing the light contrast surface.

In a fourth step 21, with the aid of the laser provided or, respectively, set in this manner, the writing 17 is produced in the regions of the contrast surface 16 that have been left free. In the process, the color change of the light base color of the object to the dark color the writing 17 is caused and the marking 13 shown in FIGS. 1 and 2 is completed.

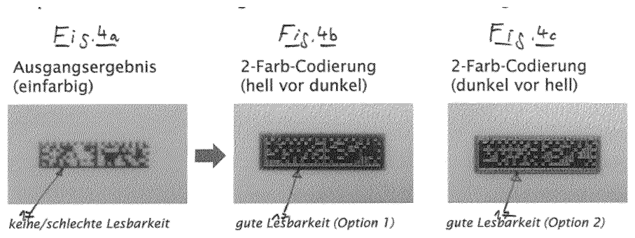

According to FIG. 4a, a writing 17 in the form of a dark color produced using laser beams in the conventional manner in an object made of plastic with a yellow color is not legible or is only poorly legible.

According to FIG. 4b, a two-color marking, introduced according to the invention using laser beams into an object made of a yellow plastic, with a light-colored writing 17 within a dark-colored contrast surface 16 has a good contrast and is easily legible.

According to FIG. 4b, a two-color marking, also introduced according to the invention using laser beams into an object made of a yellow plastic, with a dark-colored writing 17 within a light-colored contrast surface 16 also has a good contrast and is easily legible.

In a microplate made of a polypropylene with the product designation deep-well plate with a yellow color (RAL 1026), a marking with a good contrast is produced with the aid of a CO₂ marking laser-type laser with the following setting parameters:

For producing the light surfaces, the parameters of the laser are set as follows: Pulse frequency 38 kHz, scan speed 1,360 mm/s, track width 0.02 mm. For producing the dark surfaces. the parameters of the laser are set as follows: Pulse frequency 46 kHz, scan speed 2,500 mm/s, track width 0.06 mm.

1-15 (canceled)

16. A method for marking an object comprised of a plastic and for use in a laboratory, comprising:
producing a contrast surface on the plastic of the object using at least one laser beam; and
producing a writing in the contrast surface using at least one laser beam,
wherein when the contrast surface is light-colored, the writing is dark-colored, and
wherein when the contrast surface is dark-colored, the writing is light-colored.

17. The method according to claim 16, wherein the contrast surface is produced in the plastic by leaving regions free for the writing, and wherein the writing is produced only within the regions that have been left free.

18. The method according to claim 16, wherein the writing is produced in the plastic and the contrast surface is produced in the plastic only in a space next to the writing.

19. The method according to claim 16, wherein the contrast surface is produced in the plastic and is partially overwritten by the writing.

20. The method according to claim 16, wherein the writing is produced in the plastic and the contrast surface is produced partially over the writing in the plastic material.

21. The method according to claim 16, wherein the writing and the contrast surface are produced using the same at least one laser, and wherein one or more parameters of the at least one laser are changed to produce either the contrast surface or the writing.

22. The method according to claim 16, wherein the writing and the contrast surface are produced using different lasers.

23. The method according to claim 21, wherein the one or more parameters of the at least one laser comprises at least one of: power; pulse speed; scan speed; track width, focus, and color of the laser.

24. The method according to claim 16, wherein the at least one laser beam is generated by a marking laser.

25. The method according to claim 16, wherein the at least one laser beam is generated by at least one of: a CO₂ marking laser; a YVO₄ marking laser; a fiber marking laser; or a SHG marking laser.

26. The method according to claim 16, wherein the plastic comprises a color of at least one of: light-to medium-gray; yellow; red; or light-green.

27. The method according to claim 16, wherein the plastic comprises at least one additive, wherein the at least one additive brings about a stronger color change when lasered.

28. The method according to claim 16, wherein the writing comprises one of a barcode or a 2D code.

29. The method according to claim 16, wherein the plastic comprises one of the following groups: polypropylene; polyethylene; polycarbonate; polystyrene; or styrene copolymers, such as acrylonitrile butadiene styrene (ABS).

30. The method according to claim 16, wherein the object comprises at least one of: a tray or rack for holding pipette tips or vessels; a microplate; a slide; a cuvette; a cell culture vessel; a reaction vessel; or a pipette tip.

31. An object for use in a laboratory that made of a plastic, comprising:
a marking that comprises a contrast surface and a writing,
wherein when the contrast surface is light-colored, the writing is dark-colored, and
wherein when the contrast surface is dark-colored, the writing is light-colored.

32. The object according to claim 31, comprising at least one of: a tray or rack for holding pipette tips or vessels; a microplate; a slide; a cuvette; a cell culture vessel; a reaction vessel; or a pipette tip.
